(19) United States
(12) Patent Application Publication
(10) Pub. No.: US 2013/0179938 A1
(43) Pub. Date: Jul. 11, 2013

(54) Security policy management using incident analysis

(71) Applicant: International Business Machines Corporation, Armonk, NY (US)

(72) Inventors: Christopher Y. Choi, Southport (AU); Neil I. Readshaw, Parkwood (AU)

(73) Assignee: International Business Machines Corporation, Armonk, NY (US)

(21) Appl. No.: 13/660,357

(22) Filed: Oct. 25, 2012

Related U.S. Application Data
(63) Continuation of application No. 13/345,991, filed on Jan. 9, 2012.

(51) Int. Cl. G06F 21/00

(52) U.S. Cl. 726/1

(57) ABSTRACT

A security analytics system receives incident data (from an incident management system) and security policy information (from a security policy management system). The security analytics system evaluates these data sets against one another, preferably using a rules-based analysis engine. As a result, the security analytics system determines whether a particular security policy configuration (as established by the security policy management system) needs to be (or should be) changed, e.g., to reduce the number of incidents caused by a misconfiguration, to increase its effectiveness in some manner, or the like. As a result of the evaluation, the security analytics system may cause a policy to be updated automatically, notify an administrator of the need for the change (and the recommendation), or take some other action to evolve one or more security policies being enforced by the security policy management system.

### BACKGROUND OF THE INVENTION

1. Technical Field

This disclosure relates generally to security policy management for information technology (IT) systems.

2. Background of the Related Art

Information security is the process of providing a set of controls to manage risk with an end goal of demonstrating compliance with a set of regulations. Security policies specify how a set of controls operate and therefore to what extent risk may be capable of being managed. The specific values for attributes in a schema of any security policy can be modified, and such modifications may change the probability of both positive impact (effectiveness at managing risk) and negative impact (unhappy users, loss of productivity) on the environment which the policy is intended to protect.

Information security professionals and their business sponsors are sensitive to the potential negative impact of any changes to security policies in production environments. Poor user acceptance, either by a large number of users or a small number of influential users such as business leaders, can often result in the suspension of an IT security system, or in reducing its effectiveness to a small, symbolic level (through limited scope or configuration). At times, the challenge is as much a social, as opposed to a technical, one. As such, teams who determine security policy in actual IT systems usually take an approach that starts small, and that then expands gradually over time.

The expansion of a security system ideally should be linked to a defined business objective. Often, however, this goal is not achieved due to several factors. One typical factor is the difficulty in funding the team or infrastructure required to meet the business objective. Another factor is the recognition that the original business driver may have been an external one, such as a compliance regime that has since become known as lacking compelling implications for non-compliance. As such, what is often seen in practice is an IT security system that is slow to reach its potential and that is frequently in a reactive mode of operation.

It is known in the art to provide automated systems that provide for dynamic adjustment to security policy based on events or state changes occurring in the system being protected. A drawback of such an approach is that the decision to adjust security policy is limited to events in the IT system and an understanding of a desired security state, and it does not address the organization's ability to manage efficiently the incidents arising from the use of a particular security policy. Another known technique provides for automated risk assessment by reconciling a desired security policy state with a security configuration on an actual IT system.

There is a need in the art to provide for techniques to enable those responsible for policy management within an organization to optimize the evolution of a policy-based IT security system.

This disclosure addresses this need.

### BRIEF SUMMARY OF THE INVENTION

This disclosure provides for a method to optimize policy changes in an IT security system, preferably by integrating incident management information associated with use of the IT security system. According to this approach, incident data (about the IT security system) collected by an incident management system is fed back (or otherwise provided) to and used by a “security analytics system,” which system analyzes that incident data against security policy information (provided by a policy management system). Based on this analysis, the security analytics system makes (or recommends) changes to one or more security policies being managed by the security policy management system. By using feedback from an incident management system that supports the IT security system, the described techniques enable an administrator to better understand the perceived or measured effectiveness and cost of negative impact of one or more policy sets, and what changes (or recommended changes) should be made to the set of policies currently employed.

Thus, according to this disclosure, a security analytics system receives incident data from an incident management system, and security policy information from a security policy management system. The security analytics system evaluates these data sets against one another, preferably using a rules-based analysis engine. As a result, the security analytics system can determine whether a particular security policy configuration (as established by the security policy management system) needs to be (or should be) changed, e.g., to reduce the number of incidents caused by a misconfiguration, to increase its effectiveness in some manner, or the like. As a result of the evaluation, the security analytics system may cause a policy to be updated automatically, notify an administrator of the need for the change (and the recommendation), or take some other action to evolve one or more security policies being enforced by the security policy management system.

By integrating an incident management system in this manner, incident management data is used to facilitate the analysis of positive and negative impacts of security policies, providing for improved security policy management.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 depicts an exemplary block diagram of a distributed data processing environment in which exemplary aspects of the illustrative embodiments may be implemented;

FIG. 2 is an exemplary block diagram of a data processing system in which exemplary aspects of the illustrative embodiments may be implemented;

FIG. 3 illustrates a policy management system in which the techniques of this disclosure may be implemented;

FIG. 4 illustrates how the security analytics system of this disclosure interfaces, on the one hand, to a security policy management system used to define and manage security policy for a protected system, and, on the other hand, to an incident management system that collects security events associated with the protected system;

FIG. 5 illustrates a block diagram of the functional components of the security analytics system of this disclosure; and

FIG. 6 is a process flow illustrating a sample incident analysis rule that is parsed by the incident analysis engine of the security analytics system of this disclosure.

### DETAILED DESCRIPTION OF AN ILLUSTRATIVE EMBODIMENT

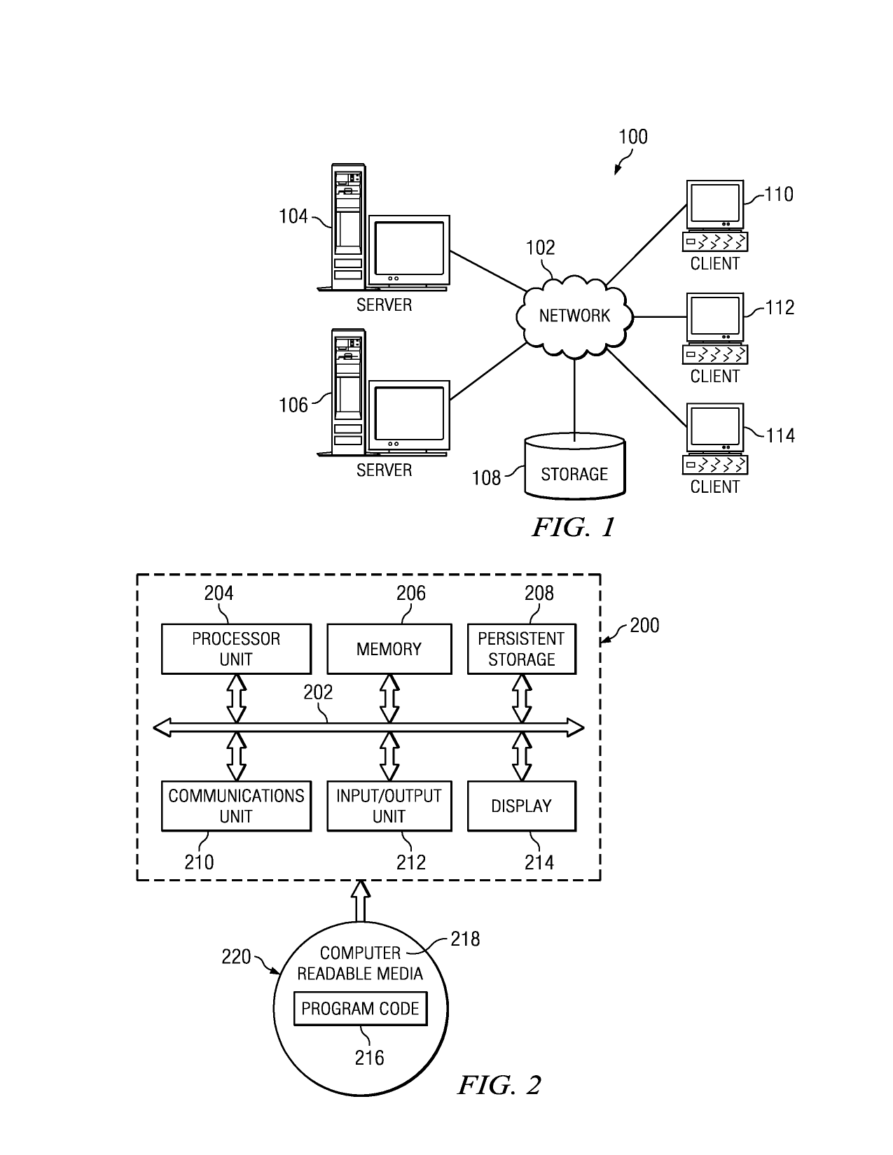

With reference now to the drawings and in particular with reference to FIGS. 1-2, exemplary diagrams of data processing environments are provided in which illustrative embodiments of the disclosure may be implemented. It should be appreciated that FIGS. 1-2 are only exemplary and are not intended to assert or imply any limitation with regard to the environments in which aspects or embodiments of the disclosed subject matter may be implemented. Many modifications to the depicted environments may be made without departing from the spirit and scope of the present invention.

With reference now to the drawings, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the disclosed subject matter, and therefore, the particular elements shown in FIG. 1 should not be considered limiting with regard to the environments in which the illustrative embodiments of the present invention may be implemented.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor (SMP) system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code. The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Computer program code for carrying out operations of the present invention may be written in any combination of one or more programming languages, including an object-oriented programming language such as Java™, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the disclosed subject matter.

As will be seen, the techniques described herein may operate in conjunction within the standard client-server paradigm such as illustrated in FIG. 1 in which client machines communicate with an Internet-accessible Web-based portal executing on a set of one or more machines. End users operate Internet-connectable devices (e.g., desktop computers, notebook computers, Internet-enabled mobile devices, or the like) that are capable of accessing and interacting with the portal. Typically, each client or server machine is a data processing system such as illustrated in FIG. 2 comprising hardware and software, and these entities communicate with one another over a network, such as the Internet, an intranet, an extranet, a private network, or any other communications medium or link. A data processing system typically includes one or more processors, an operating system, one or more applications, and one or more utilities. The applications on the data processing system provide native support for Web services including, without limitation, support for HTTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP and XML is available from Internet Engineering Task Force (IETF). Familiarity with these standards is presumed.

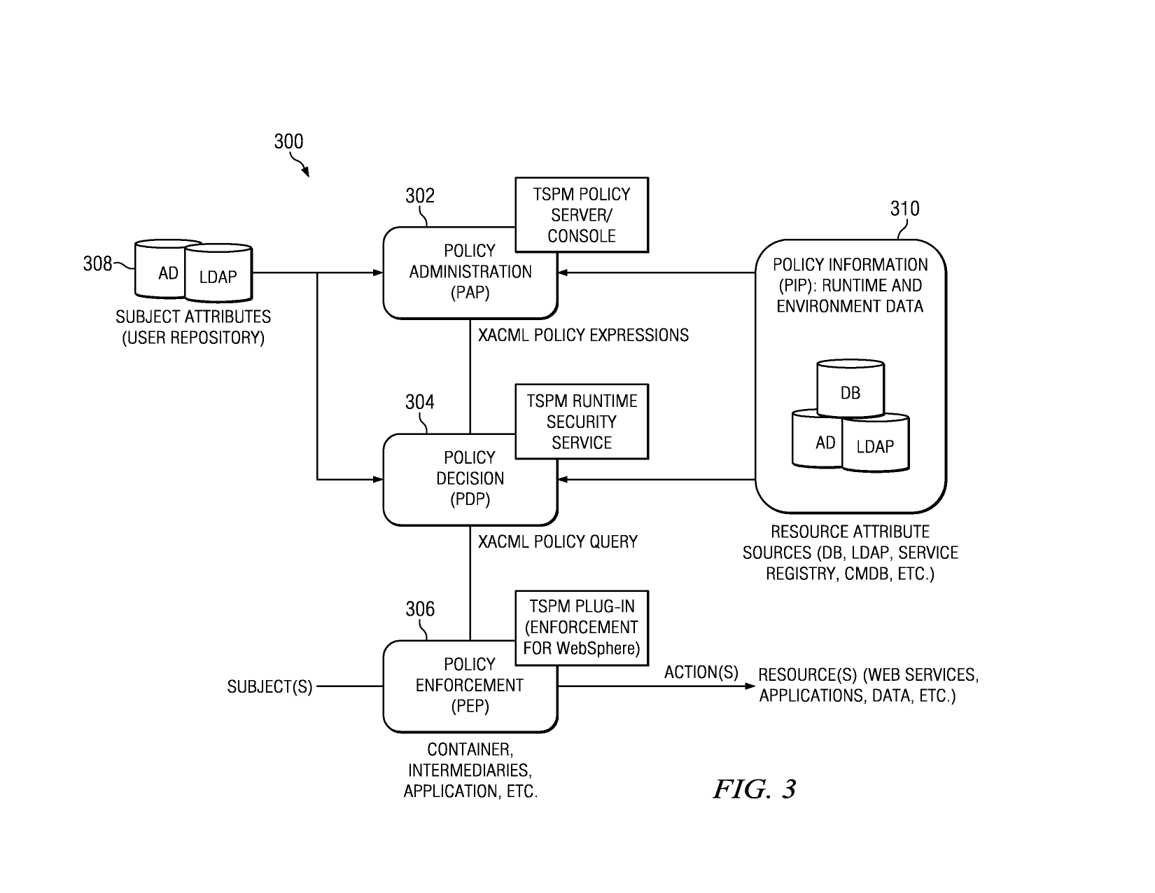

As will be described, this disclosure uses “incident analysis” data (such as provided by an incident management system, to improve security policy management. Security policy management systems are known in the prior art. FIG. 3 illustrates a representative security policy management system 300 in which the below-described technique may be implemented. As is well known, the system 300 may be implemented across one or more machines operating in a computing environment, such as shown in FIG. 1. Typically, the system comprises a policy administration point (PAP) 302, a policy decision point (PDP) 304, and a policy enforcement point (PEP) 306. Generally, the policy administration point 302 is used to define a policy, which may be specified as a set of XACML policy expressions. This policy uses subject attributes provided from a user repository 308, as well runtime and environment data received from policy information point (PIP) 310. The policy decision point (PDP) 304 receives similar information and responds to an XACML policy query received from the policy enforcement point (PEP) 306 to enforce the policy on a subject and with respect to a particular action initiated by the subject. In one commercial implementation of this approach, the PAP 302 is implemented by IBM® Tivoli® Security Policy Manager (TSPM) policy service/console, the PDP 304 is implemented in the TSPM runtime security service, and the PEP is implemented as a TSPM plug-in to WebSphere® Application Server.

A “policy” may refer to a single policy, or a set of policies (a “policy set”). A security policy management system such as described above and illustrated in FIG. 3 typically is coupled to a “protected system,” which refers to the system that is subject to a particular security policy configured and enforced by the security policy management system. A “protected system” as used herein may be quite varied and refers to any service, products, machines, sets of machines, appliances, devices, data stores, databases, and the like, that are subject to a security policy. For, the protected system may be a database management system, a Service Oriented Architecture (SOA) appliance, a Data Loss Prevention (DLP) endpoint, and so forth. There is no limitation to the type of protected system that may be protected by a security policy created by the security policy management system. As is well known, a security policy management system such as shown in FIG. 3 may be tightly or loosely coupled with the protected system.

A protected system may have associated therewith an incident management system that provides systems for streamlining incident and problem management. Incident management is a well-defined business process, typically involving a “service desk” and the associated system and resources used to collect and service problems across a computing infrastructure, as well as non-IT related data points. Known incident management systems, such as IBM Tivoli Service Request Manager (TSRM), are available commercially, and these systems can provide a single point of contact across an enterprise to help manage incidents and problems. These types of systems typically consolidate incidents from multiple sources, such as end users, service technicians, the non-IT related data points, and network systems management/monitoring applications. An incident management system of this type typically provides a number of capabilities and services such as, without limitation, self-service support to end users, a knowledge base to assist help-desk agents, automated responses to certain ticket types or event classifications, real-time performance views, change and release management capabilities, service level agreement tracking, integrated asset management, and the like.

Security events associated with the protected system are provided to (collected by) the incident management system in a known manner and using known interfaces.

### Security Policy Management Using Incident Analysis

With the above as background, the subject matter of this disclosure is now described.

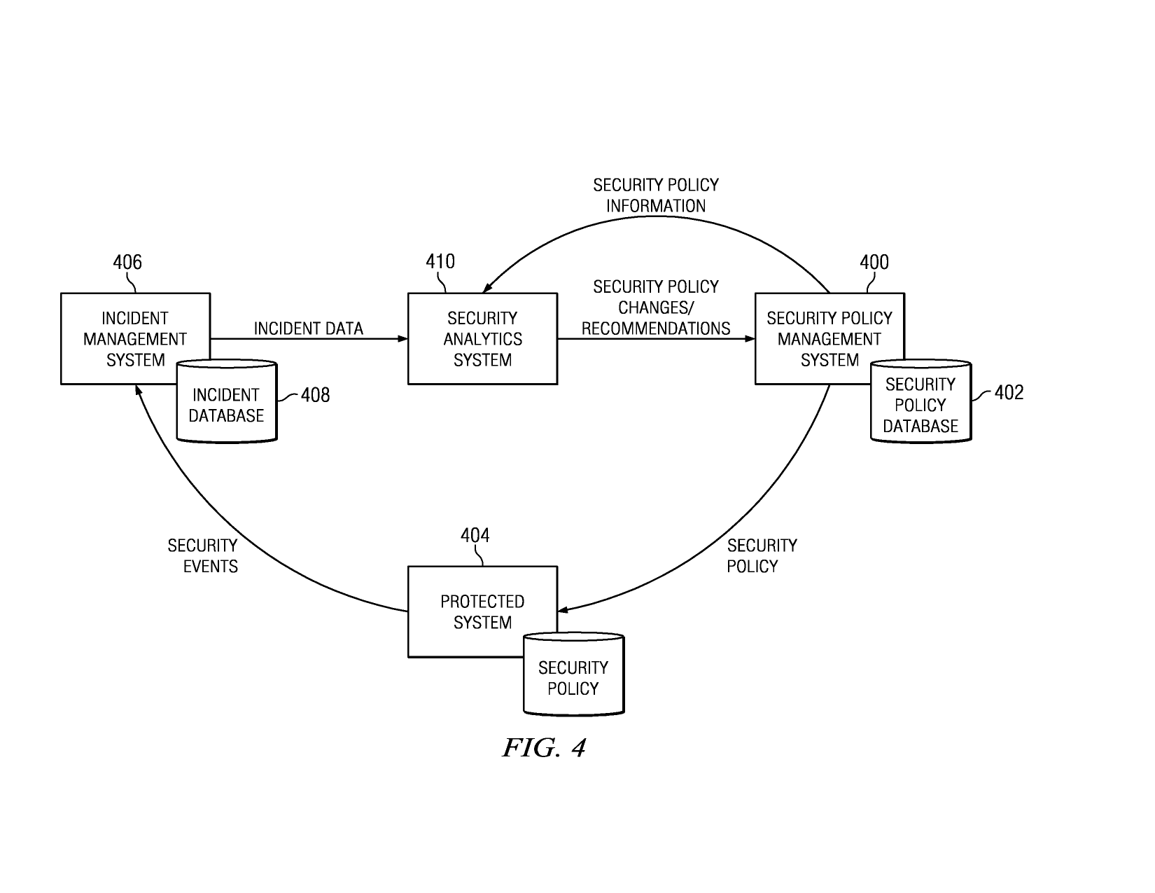

According to this disclosure, and with reference now to FIG. 4, a security analytics system 410 preferably receives information from both a security policy management system (PMS) 400, such as described above with respect to FIG. 3, and from an incident management system (IMS) 406. As noted above, the incident management system 406 typically is an enterprise solution capable of tracking incidents, which are stored in incident database 408. The security policy management system 400 stores security policy sets in a security policy database 402. One or more of those security policy sets comprise a security policy that is applied to a protected system 404. According to this approach, and as illustrated, the security analytics system 410 receives incident data from the incident management system 406, and it receives security policy information from the security policy management system 400. Generally, the security analytics system 410 compares these data sets (in a manner to be described below) to generate one or more security policy changes or recommendations that are provided back to (or applied within) the security policy management system 400. In this manner, one or more security policies are evolved by taken into consideration incident data associated with the protected system. This integration (by the security analytics system) of incident data, on the one hand, and security policy information, on the other hand, provides significant advantages, as will be described.

Without limitation, the security analytics system may be implemented as any type of computing entity, for example, in a data processing system such as illustrated in FIG. 2, as a client-server based computing system such as illustrated in FIG. 1, or in any other manner.

Another alternative implements the security analytics system as a cloud-based service (in a cloud-computing environment). Yet another alternative is a standalone software system. The security analytics system may be a component of either the security policy management system, or the incident management system, the protected system, or any other system. The security analytics system may be implemented as a product, a service, a machine, a set of machines, one or more servers, one or more processes, one or more programs, or the like. The security analytics system typically includes management interfaces (such as a web-based graphical user interface (GUI), a command line interface (CLI), or the like) for administration, configuration and management. The security analytics system may be implemented in a middleware appliance. In one embodiment, the system operates in a web-based computing environment and is accessible over a network, such as a private network, the public Internet, or the like. The system may operate within a computing environment, or across multiple environments.

Thus, the security analytics system 410 of FIG. 4 may be implemented in a variety of deployment scenarios. In one approach, if the security policy management system 400 is a standalone solution, then the security analytics system 410 may be implemented as a component thereof. If the incident management system 406 is a standalone solution, then the security analytics system 410 may be implemented as component thereof. In a Professional Services (PS) context, the security analytics system may be implemented as a standalone system, preferably loosely coupled with both the incident management and security policy management systems. Those skilled in the art will appreciate that other implementations and use cases for the security analytics system also are within the scope of this disclosure.

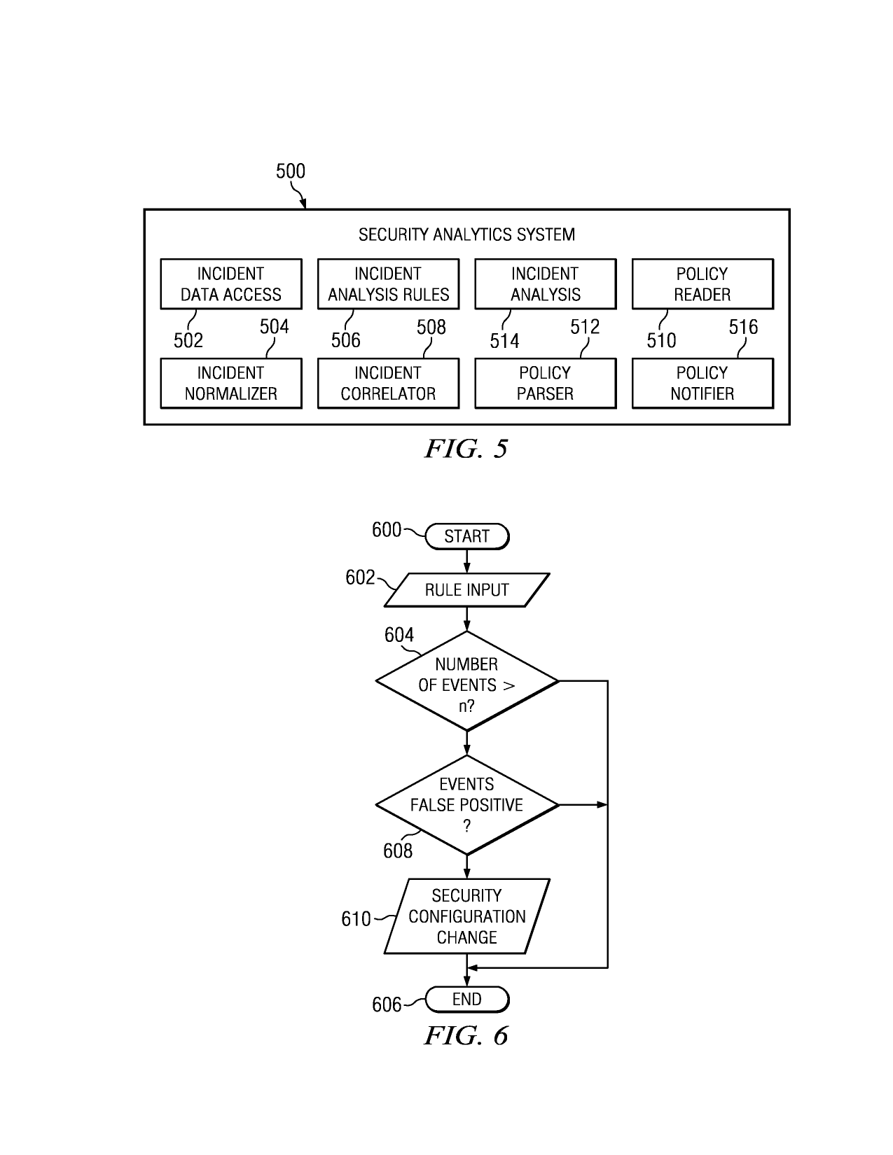

FIG. 5 is a block diagram representing a security analytics system 500. The various functional components of this system include an incident data access component 502, an incident normalizer component 504, an incident analysis rules component 506, an incident correlation component 508, a policy reader component 510, a policy parser component 512, and incident analysis component 514, and a policy writer (or notification) component 516. One or more of such components (or “functions”) may be combined with one another, and the nomenclature used here is merely intended for exemplary purposes. Each such component typically is implemented in software, as a set of computer program instructions, executable on one or more processors, to comprise a special-purpose computing entity or machine. In the alternative, a particular component is implemented as a machine, device, system, process, program or execution thread. A component typically includes or has associated therewith one or more data sets. Such components and data typically are stored in computer memory or one or more data stores.

The incident data access component 502 retrieves data about security incidents pertaining to the security policies and protected systems being managed by the security policy management system employing the security analytics system. The techniques for retrieving the data are dependent on the incident management system being used; typically, these techniques include, without limitation, a database query (JDBC/JPA/ADO), a SOAP/HTTP-based web service, a remote procedure call (RPC), or some other application programming interface (API).

The incident normalizer component 504 translates incident data for use in the incident analysis component 514. In particular, and depending on the schema of the incident data from the external system, this function typically involves one or more of the following operations: filtering particular data elements, combining data elements, enrichment (from other data sources), mapping (for a particular data element) from one enumeration to another, or any other type of data transformation. In general, the incident normalizer component 504 transforms the incident data as needed to ensure that the incident data can be associated with the policies from the security policy management system, and further that any data elements required by the incident analysis rule component 506 are present.

The incident normalizer component 504 advantageously filters out noise or other artifacts that might otherwise negatively impact the analysis. The incident normalizer component primarily is responsible for summarizing and aggregating incident data. This component need not be aware of any policies and how they can or do impact the generation of incidents. Typically, component 504 thus is responsible for doing rudimentary data processing to ensure that complete and concise information is delivered to the incident analysis. For example, in an incident report there may be data, such as the user's telephone number, that may be irrelevant for the incident analysis (as opposed to other data, such as user's role, location and texts (such as “logon failure”) that may help identify the set of policies related to the incident). The normalizer component might then be configured to filter out the telephone number.

Of course, this example is merely representative of the type of “normalization” processing performed by the incident normalizer component, and it should not be considered as limiting.

The incident analysis rules module 506 provides one or more rules and other configuration information to control how outputs from the incident analysis module 514 are or should be derived based on the various inputs to that module. The incident correlation module 508 correlates incidents as similar according to one or more attributes, such as system identifiers, user identity attributes, roles and associated policies, and the like. The incident correlation module 508 provides input to the incident analysis module 514, which acts as a processing engine on that data (based on the incident analysis rules) for calculating policy changes (or suggested policy changes). The incident analysis component may work on a single security policy or a set of security policies. The granularity of what constitutes a single security policy typically varies across different security policy management systems.

The policy reader module 510 obtains current state of security policies from the security policy management system, such as the system shown in FIG. 3. The techniques for retrieving the data are dependent on the security policy management system used; typically, the techniques include, without limitation, a database query (JDBC/JPA/ADO), a SOAP/HTTP-based web service, a remote procedure call (RPC), or some other application programming interface (API).

The policy parser module 512 is used by the policy reader module 510 to convert data between an internal representation of policy (e.g., Java™ or Microsoft®.NET objects) and the format of policy (e.g. XML document) typically obtained from an interface to the security policy management system.

The policy writer module 516, which also interfaces to the policy parser module 512 as needed, operates to store the security policy changes into the security policy management system. The techniques for writing the data are dependent on the security policy management system being used; typically, techniques include, without limitation, a database query (JDBC/JPA/ADO), a SOAP/HTTP-based web service, a remote procedure call (RPC), or some other application programming interface (API). In an alternate implementation, rather than writing policy back to the security policy management system, the policy writer module 516 may instead provide a notification to an administrator of a recommended change to one or more security policies. In such case, any standard messaging mechanism may be used, such as e-mail via SMTP. If the security policy management system supports provisional policies, or the ability to store multiple versions of a same policy, the policy writer module 516 may provide appropriate updates to the security policy management system to effect the desired changes. In yet a further alternative, the policy writer may simply identify a particular policy or policy set as a new version (or an existing policy) with a different risk assessment.

As described above, the incident analysis rules control how the incident analysis outputs are generated. FIG. 6 illustrates a process flow for a representative incident analysis rule for the Data Loss Prevention (DLP) domain. Typically, an incident analysis rule operates on a defined set of inputs (input data) provided from the incident management system with respect to an incident (or set of incidents). In this DLP example, these inputs may include one or more of the following inputs: number of incidents for a given incident type, system where the incident originated, associated user and the user's roles, associated policies, incident classification and resolution (e.g., false positive, false negative, invalid policy, and the like), incident lifetime, and trend data of incident arrival and resolution. The rule then specifies a decision tree for generating output that specifies how the security policy configuration needs to be changed, either to reduce the number of incidents caused by misconfiguration or to increase its effectiveness. In the case where the policy (or a set of policies) needs to be updated automatically, preferably the output comprises a set of policy attributes, such as “new enforcement action” (having values of allow, audit and deny), together with the “users affected” by the change.

FIG. 6 illustrates this rule processing (for a sample rule). The routine starts at step 600. At step 602, the various inputs to the rule are obtained. The routine then continues at step 604 to test whether a number of incidents for a given incident type (the number of “events”) exceeds a given value “n.” If not, the processing of the rule ends at step 606. If the outcome of the test at step 604 is positive, however, the routine continues at step 608 to test whether the events represent a false positive. If so, once again the routine terminates. If, however, the number of events has been exceeded and the events do not represent a false positive, a security configuration change is implemented. This is step 610. The process then terminates.

Each incident analysis rule implements its own process flow from a set of predefined decisions, data elements and directed transition lines. The particular details of a particular rule are outside the scope of this disclosure. Preferably, a typical implementation provides a mechanism to extend an existing set of rule constituents via scripting or regular expressions. The incident analysis rules may be stored as XML or in a database or other data storage mechanism. The security analytics system also may provide a web-based graphical user interface (GUI) or the like to enable incident analysis rules to be authored. Commercial systems that may be used to provide this rule authoring capability include, without limitation, IBM Classification Workbench™ or IBM Security Identity Manager™.

The particular rule definitions may be quite varied and will often depend on the security needs of the organization, irrespective of the security technology domain being managed. Nevertheless, the following are representative scenarios and rule definitions.

If the IT system has reached a steady state in terms of arrival of new incidents and closure of existing incidents, then a stricter set of policies can be deployed that then diminishes as the users' behavior change. This state is distinguished from the state resulting from ineffective security configuration by noting an initial peak of arrival rate shortly after a new set of policies have been deployed. The assumption is that the current security configuration is effectively deterring the user behavior that result in these security incidents.

If the arrival rate of new incidents is unexpectedly small, then this may be an indication that the policies are not effective. For example, if very little content is being classified as sensitive, then either the classification process is inadequate or the policy is not being applied to sufficient numbers of targets. Also, this situation is likely to be a reason to increase the impact of a set of security policies.

If a large number of false positive incidents are being reported for users of a particular role, then the policy-to-role mapping may not be correct.

If an average lifetime of an incident is very long, then there may be a capacity issue (e.g., with an operations team). In this example, the incident analysis should recommend either increasing the staff capacity or the use of a less-strict set of policies until the capacity issue has been resolved.

In general, the approach described enables incident data to be used to define an incident analysis rule that may relax a given policy, e.g., because the policy is causing too many incidents, or make the policy stricter, e.g., because the number (or rate) of incidents is below an expected (or configurable) value.

Policy management using incident analysis according to this disclosure provides significant advantages. It improves the manner by which an organization operates or maintains the environment protected by a security policy management system. It enables the operator to more effectively optimize the evolution of a policy-based IT security system. In particular, by combining feedback from an incident management system (that supports the IT security system) with the perceived or measured effectiveness (or negative impact) of one or more policy sets, the technique enables changes (or recommended changes) to the security policy or policies currently in place. The approach of using incident analysis to manage security policy explicitly closes the loop between operational and policy management aspects of an IT security system. The approach accelerates the increase in effectiveness and positive impact of an IT security system. Further, the approach helps ensure that roll-out of a security system is not outpacing staffing of an operational team that is required to support it. Finally, the technique provides an evidence-based mechanism for improving security policies that, preferably, is built into the IT system itself.

The particular techniques may be used to facilitate management of any type of policy including, without limitation, a security policy, an access policy, a data loss prevention policy (such as in a DLP system), an identity provisioning policy, a web access control policy, and the like.

As previously noted, the functionality described above may be implemented as a standalone approach, e.g., a software-based function executed by a processor, or it may be available as a managed service (including as a web service via a SOAP/XML interface). The particular hardware and software implementation details described herein are merely for illustrative purposes are not meant to limit the scope of the described subject matter.

More generally, computing devices within the context of the disclosed subject matter are each a data processing system (such as shown in FIG. 2) comprising hardware and software, and these entities communicate with one another over a network, such as the Internet, an intranet, an extranet, a private network, or any other communications medium or link. The applications on the data processing system provide native support for Web and other known services and protocols including, without limitation, support for HTTP, FTP, SMTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP, FTP, SMTP and XML is available from Internet Engineering Task Force (IETF). Familiarity with these known standards and protocols is presumed.

The scheme described herein may be implemented in or in conjunction with various server-side architectures including simple n-tier architectures, web portals, federated systems, and the like. The techniques herein may be practiced in a loosely-coupled server (including a “cloud”-based) environment.

Still more generally, the subject matter described herein can take the form of an entirely hardware embodiment, an entirely software embodiment or an embodiment containing both hardware and software elements. In a preferred embodiment, the function is implemented in software, which includes but is not limited to firmware, resident software, microcode, and the like. Furthermore, as noted above, the DLP policy association functionality described herein can take the form of a computer program product accessible from a computer-usable or computer-readable medium providing program code for use by or in connection with a computer or any instruction execution system. For the purposes of this description, a computer-usable or computer readable medium can be any apparatus that can contain or store the program for use by or in connection with the instruction execution system, apparatus, or device. The medium can be an electronic, magnetic, optical, electromagnetic, infrared, or a semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. The computer-readable medium is a tangible item.

The computer program product may be a product having program instructions (or program code) to implement one or more of the described functions. Those instructions or code may be stored in a computer readable storage medium in a data processing system after being downloaded over a network from a remote data processing system. Or, those instructions or code may be stored in a computer readable storage medium in a server data processing system and adapted to be downloaded over a network to a remote data processing system for use in a computer readable storage medium within the remote system.

In a representative embodiment, the security analytics system or one or more of its component sub-systems are implemented a special purpose computer, preferably in software executed by one or more processors. The software is maintained in one or more data stores or memories associated with the one or more processors, and the software may be implemented as one or more computer programs. Collectively, this special-purpose hardware and software comprises or supplements an existing policy management solution, as has been described

In a representative embodiment, a security policy management central management console exposes one or more web-based interfaces that may be used to create and/or modify an incident analysis rule in the manner described.

As noted, the described security analysis functionality (i.e., the use of incident analysis to improve security policy management) may be implemented as an adjunct or extension to an existing policy management solution, incident management system, protected system, or the like.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Finally, while given components of the system have been described separately, one of ordinary skill will appreciate that some of the functions may be combined or shared in given instructions, program sequences, code portions, and the like.

Any application or functionality described herein may be implemented as native code, by providing hooks into another application, by facilitating use of the mechanism as a plug-in, by linking to the mechanism, and the like.

As noted, the above-described security analytics system function may be used in any system, device, portal, site, or the like wherein it is desired to analyze data for managing security policies.

Having described our invention, what we now claim is as follows:

1. A method to manage policy changes in an information technology (IT) security system, comprising:
receiving incident data associated with one or more security incidents occurring within the IT security system;
receiving security policy data associated with a security policy in effect within the IT security system;
applying an incident analysis rule to the received incident data and the received security policy data to calculate a change to one or more attributes of a new security policy for the IT security system; and
associating the one or more attributes of the new security policy to the IT security system.

2. The method as described in claim 1 wherein the incident data is received from an incident management system that supports the IT security system.

3. The method as described in claim 1 wherein the incident data includes one of: a number of incidents, a number of incidents for a given incident type, an identifier of a system in which an incident originates, a user or user role associated with an incident, an incident classification and resolution, an incident lifetime, and trend data of incident arrival and resolution.

4. The method as described in claim 1 wherein the rule quantifies an effectiveness of the security policy.

5. The method as described in claim 1 wherein the rule quantifies an impact of a change of the security policy

6. The method as described in claim 1 wherein the one or more attributes of the new security policy are associated in an automated manner.

7. The method as described in claim 1 wherein the one or more attributes of the new security policy are associated by providing an administrator with a notification.

8. The method as described in claim 1 wherein the new security policy is one: a policy that replaces the security policy in effect within the IT security system, a variant of the security policy in effect within the IT security system, and an update to the security policy in effect within the IT security system.
